(19) United States
(12) Patent Application Publication
(10) Pub. No.: US 2012/0111976 A1
(43) Pub. Date: May 10, 2012

(54) Process for Milling Cermet or Cemented Carbide Powder Mixtures

(76) Inventors: Mathias Tillman, Taipei (TW); Carl-Johan Maderud, Stockholm (SE)

(21) Appl. No.: 13/266,515

(22) PCT Filed: Apr. 28, 2010
(86) PCT No.: PCT/SE2010/050470

§ 371 Date: Jan. 23, 2012

(30) Foreign Application Priority Data
Apr. 29, 2009 (EP) 09159011.7

(51) Int. Cl. B02C 23/18

(52) U.S. Cl. 241/15

(57) ABSTRACT

The present invention relates to a process for milling a cermet or cemented carbide powder. The process comprises circulating a slurry comprising powder(s) forming hard constituents, powder(s) forming binder phase and a grinding liquid through a grinding chamber. The grinding chamber comprises grinding elements and an agitator where the agitator is rotating around an essentially horizontal axis. The process according to the present invention provides a cermet or cemented carbide powder mixture at a significantly reduced milling time.

The present invention relates to a process of milling a cermet or cemented carbide powder with a significantly reduced milling time. The present comprising circulating a slurry comprising powder(s) forming hard constituents, powder(s) forming binder phase and a grinding liquid through a grinding chamber comprising grinding elements and an agitator rotating around a horizontal axis.

### BACKGROUND

The main principles of cermet or cemented carbide production have been known for over 50 years. The powders forming hard constituents, e.g. TiC, WC, TiCN etc. and the powders forming binder phase are grinded in a conventional ball mill together with a grinding fluid and possibly a pressing agent. The slurry is then usually spray dried to form an agglomerated powder which is pressed into green bodies and then sintered into substrates for cutting tools etc.

The mills used for grinding the powders have historically been conventional ball mills, i.e. rotating cylindrical mills filled with grinding elements. The grinding time required to obtain a homogenous powder mixture as well as to obtain the aimed grain size is quite long, milling times of 40 hours are not uncommon.

During recent years, it has been an increasing demand of more fine grained grades. This requires more intensive grinding and for that attritor type mills have often been used. The attritor mills are vertical ball mills provided with means for agitation in order to activate the grinding elements. Although this gives cemented carbide powders having small grain sizes, the milling time is still long and there are several technical disadvantages with this type of mills, a wide particle size distribution and significant amounts of large grains due to dead zones in the grinding chamber. However, these types of mills suffer from an uneven distribution of grinding elements in the grinding chamber. Some of the disadvantages can be improved by the use of a circulation pump, but such attritor mills also have the disadvantage that the outlet can get blocked by the grinding elements if the size of the bodies is reduced, thus setting a lower limit for the size of the grinding elements.

The properties of the powders used for making cutting tools are very important since cutting tools are subjected to heavy loads when used in cutting operations and thus even very small defects in the cutting tool material can cause tool failure.

The quality of the powder mixture affects to a large extent the properties of the sintered body. Large grains in the sintered micro structure may initiate failures in fine grained grades and thus the amount of large grains should be minimized. A large fraction of fines in the powder can lead to growth of abnormal grains during sintering, thus increasing the demand for a narrow grain size in the milled powder. Another purpose with the milling is to obtain a homogenous powder mixture with as little variation as possible. It is very important to get a good mixing between the powders forming hard phase and the powders forming binder phase to achieve a uniform sintered micro structure.

Horizontal agitated mills are known in the art for other applications such as for grinding printing ink, pigments for coatings and technical ceramics.

EP 0 448 100 B1 describes an agitator mill with a horizontal milling chamber comprising grinding bodies and where the grinding stock is recirculated. The milling chamber is further provided with a separator placed at the outlet at the center axis of the milling chamber. The agitator mill of EP 0 448 100 B1 claims to solve the problem with wear of the separator which is reduced.

There is an object of the present invention to provide a process for milling a cermet or cemented carbide powder mixture with a reduced milling time.

There is an object of the present invention to provide a process for making a cermet or cemented carbide powder mixture with a decreased amount of large grains as well as fraction of fines.

There is yet another object of the present invention to provide a process of making a cermet or cemented carbide powder mixture having an improved homogeneity.

It has now been found that maintained or improved properties of cermet and cemented carbide powder(s), and also of the products made thereof, can be obtained by circulating a slurry of the powder and milling the slurry in a grinding chamber provided grinding elements and with an agitator rotating around a horizontal axis can be obtained at a significantly reduced milling time.

### DESCRIPTION OF DRAWINGS

FIG. 1 shows a schematic drawing of one embodiment of the milling apparatus that is used in the process according to the present invention. The apparatus comprises a grinding chamber (1) comprising an agitator (2) and an inlet (3) and an outlet (4). Further, the grinding chamber is provided with rotating means (6) in order to rotate the agitator (2) around a center axis (5). The apparatus further comprises a stirred tank (7) and means for circulation (8). The apparatus is also provided with means for measuring temperature (9) and means for measuring the pressure (10).

FIG. 2 shows a schematic drawing of one embodiment of the grinding chamber (1) provided with separating means (11) to separate the slurry that is grinded from the grinding bodies (12) placed inside the grinding chamber (1).

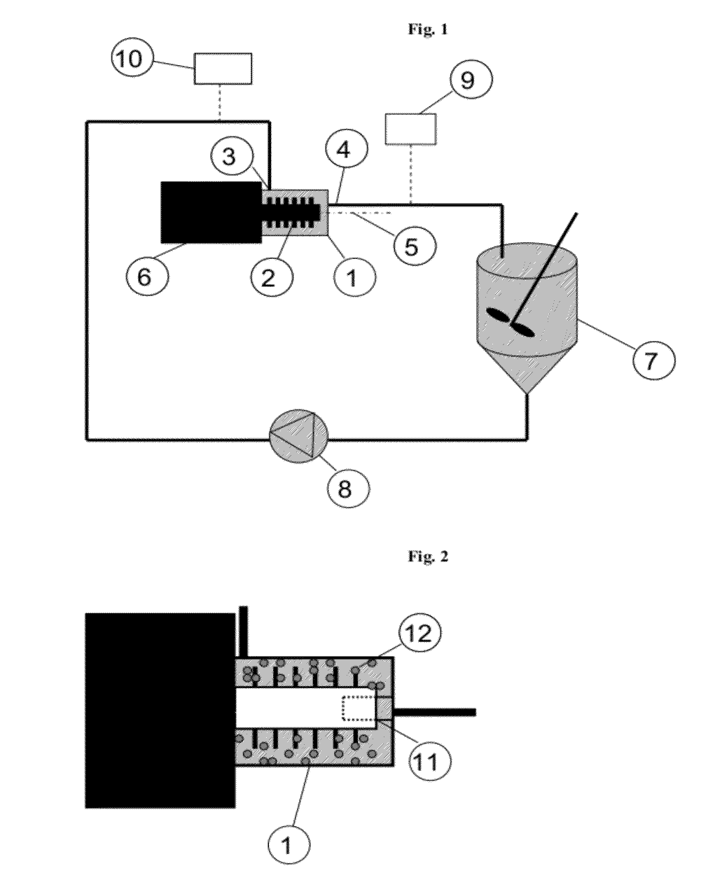

### THE INVENTION

The present invention relates to a process for milling a cermet or cemented carbide powder comprising circulating a slurry comprising powder(s) forming hard constituents, powder(s) forming binder phase and a grinding liquid through a grinding chamber comprising grinding elements and an agitator, wherein the agitator is rotating around an essentially horizontal axis.

By essentially horizontal is herein meant that a small inclination can be allowed as long as it does not disturb the grinding process, preferably the inclination is less than 10 degrees, more preferably less than 5 degrees and most preferably the axis is horizontal.

The grinding chamber is further provided with an inlet and an outlet where the grinding slurry can enter and exit the grinding chamber. Also, the circulation is done by means for circulation, preferably a pump. The slurry is preferably circulated through a stirred tank before returning to the grinding chamber.

The grinding elements are preferably in the shape of spheres having a diameter between 0.2-4 mm, preferably between 0.5-2 mm. The grinding bodies are preferably made of cemented carbide.

The agitator is preferably placed in the grinding chamber so that it is rotating around the essentially horizontal axis placed in the center of the grinding chamber so that the grinding slurry together with the grinding elements is kept in motion. The apparatus is also provided with means for rotating the agitator preferably a motor.

The grinding chamber is preferably further provided with separating means at the outlet to separate the grinding elements from the grinding slurry so that the grinding elements do not leave the grinding chamber. The separating means is preferably a sieve.

In one embodiment of the present invention, the outlet and the separating means are placed at the essentially horizontal axis in the center of the grinding chamber in one end of the grinding chamber. Preferably the separating means are protruding into the hollow agitator. This can be beneficial when the grinding elements with smaller diameters are used. By placing the outlet and the separating means at the essentially horizontal axis in the center of the grinding chamber it is possible to avoid the separating means to be clogged with grinding elements since centrifugal forces will prevent the grinding elements to concentrate and block the outlet.

In one embodiment of the present invention, the powder(s) forming hard constituents, the powder(s) forming binder phase, the grinding liquid and any other additions are premixed into a slurry before they are added to the milling apparatus, preferably by means of a separate mixer.

The powders forming hard constituents can be any powder common in the making of cermet and cemented carbide, suitably powders of one or more of WC, TiC, TaC, NbC, Cr₃C₂, VC, TiCN and TiN.

The powders forming binder phase are preferably one or more of Co, Ni or Fe, preferably Co. The powders forming binder phase are preferably added in an amount of from 2 to 30 wt %, preferably from 6 to 12 wt %, based on the total dry powder weight.

The grinding liquid can be any liquid. The grinding liquid is preferably water, an alcohol or an organic solvent, more preferably water or a water and alcohol mixture and most preferably a water and ethanol mixture. The amount of grinding liquid added is dependent on the properties of the slurry. Since the drying of the slurry requires energy, the amount of liquid should be minimized in order to keep costs down. However, enough liquid need to be added in order to pump the slurry and avoid clogging of the system.

In one embodiment of the present invention, a pressing agent is also added to the grinding chamber together with the powders and the grinding liquid. The pressing agent can be any pressing agent known in the art of making cermets or cemented carbide, preferably the pressing agent is polyethylene glycol (PEG) or wax. The amount of pressing agent is preferably between 15 and 25 vol % based on the total dry powder volume.

In one embodiment of the present invention a cermet powder is made and the powders forming hard constituents are preferably one or more of TiC, TiCN and WC. The powders forming binder phase are preferably one or more of Co, Ni or Fe.

In one embodiment of the present invention a cemented carbide powder is made and the powders forming hard constituents are preferably mainly WC. Smaller amount of other carbides such as grain refining carbides and gamma phase forming carbides can also be added. The powders forming binder phase are preferably Co.

The WC grain size of the powder prior to grinding can vary within a wide range depending on the end use of the powder, from 0.1 to 18 μm. When the powder will be used to produce cemented carbide bodies for rock drilling, rolls for hot rolling, wear parts etc. the WC grain size of the powder prior to grinding is suitably between 1 and 18 μm, preferably between 2 and 10 μm. If cutting tools like inserts, drills and end mills are made the WC grain size of the powder prior to grinding is suitably between 0.4 and 5 μm, preferably between 0.8 and 4 μm.

Very fine grained WC powder is especially suitable for the production of PCB-drills which require a very small average grain size, where the WC grain size suitably is between 0.1 and 0.8 μm, preferably between 0.2 and 0.6 μm.

### EXAMPLE 1

An ultrafine powder, Invention 1, with additions of Co, vanadium carbide and chromium carbide in amounts according to Table 1 was made using a horizontal agitated ball mill “Labstar” from Netzsch Feinmahl Technik fitted with a “Z” grinding system. A 5 kg (dry) batch was weighed in and mixed with 1.75 l of ethanol acting as a grinding liquid. The resulting slurry was ground for 50 minutes (10 min/kg) with an agitator speed of 1500 rpm using 4400 g of Ø 1.15 mm grinding balls after which the batch was spray dried.

For comparison a powder having the same starting composition as Invention 1 was milled for 40 hours (4.3 min/kg) in a production size ball mill (560 kg powder in a 600 liter mill). The WC used had an as supplied grain size of 0.65 μm (FSSS), the cobalt used was ultrafine cobalt from Umicore.

TABLE 1

| | Powder composition prior |
|---|---|
| | to grinding in wt % |
| Co | 6.2 |
| V (added as VC) | 0.49 |
| Cr (added as Cr₃C₂) | 0.26 |
| WC | Balance |

Both the powder made according to the present invention, Invention 1, and the powder made according to conventional methods, Reference 1, was sintered in the same manner at a temperature of 1450° C. The results can be seen in Table 2.

TABLE 2
Properties for samples sintered in GPS
(gas pressure sintering) 1450° C.

| | Invention 1 | Reference 1 |
|---|---|---|
| HC (kA/m) | 41.62 | 39.3 |
| Com (%) | 5.35 | 5.16 |
| Density | 14.75 | 14.76 |
| HV_{30 kg} | 2077 | 2033 |
| Porosity | A00, B00, C00 | A00, B00, C00 |
| Coarse Grains (5-10 μm/cm²) | 0 | 0.81 |
| TRS mean (MPa) | 4502 | 4326 |

In Table 2 it can clearly be seen that the sintered bodies made from the powders made according to the present invention, Invention 1, shows improved values regarding TRS and coarse grain count compared to the sintered bodies made from the powders grinded in conventional ball mills.

### EXAMPLE 2

A fine grained grade, invention 2, with additions of Co, vanadium carbide and chromium carbide in the amounts as shown in Table 3 was made using the same Labstar-mill from Netzsch Feinmahl Technik as in Example 1. A 10 kg (dry) batch was weighed in and mixed with 2.7 l of ethanol acting as a grinding liquid. The resulting slurry was ground for 63 minutes (6.3 min/kg) with an agitator speed of 1650 rpm using 4400 g of Ø 1.15 mm grinding balls after which the batch was spray dried.

For comparison a reference powder, Reference 2, was milled for 40 hours (4.3 min/kg) in a production size ball mill (560 kg powder in a 600 liter mill). The carbide used had an as supplied grain size of 0.85 μm (FSSS), the cobalt used was extra fine cobalt from Umicore.

TABLE 3

| | Powder composition prior |
|---|---|
| | to grinding in wt % |
| Co | 10.0 |
| Cr (added as Cr₃C₂) | 0.39 |
| WC | Balance |

Both the powder made according to the present invention, Invention 2, and the powder made according to conventional methods, Reference 2, was sintered in the same manner at a temperature of 1410° C. The results can be seen in Table 4.

TABLE 4
Properties for samples vacuum sintered in 1410°C.

| | Invention 2 | Reference 2 |
|---|---|---|
| HC (kA/m) | 19.82 | 20.37 |
| Com (%) | 8.99 | 8.48 |
| Density | 14.49 | 14.50 |
| HV_{3 kg} | 1591 | 1589 |
| Porosity | A00, B00, C00 | A00, B00, C00 |
| Coarse Grains (5-10 μm/cm²) | 3.1 | 30.1 |

In Table 4 it can clearly be seen that the sintered bodies made from the powders made according to the present invention, Invention 1, shows similar or improved rate of coarse grains compared to the sintered bodies made from the powders grinded in conventional ball mills.

1. A process for milling a cermet or cemented carbide powder comprising circulating a slurry comprising powder(s) forming hard constituents, powder(s) forming binder phase and a grinding liquid through a grinding chamber comprising grinding elements and an agitator, wherein the agitator is rotating around an essentially horizontal axis.

2. A process according to claim 1 wherein the powder(s) forming hard constituents are one or more of WC, TiC, TaC, NbC, Cr₃C₂, VC, TiCN and TiN.

3. A process according to claim 1 wherein the powder(s) forming binder phase is one or more of Co, Ni or Fe in an amount of 2 to 30 wt % based on the total dry powder weight.

4. A process according to claim 1 wherein a pressing agent being polyethylene glycol or wax is added to the milling apparatus in an amount of between 15 and 25 vol % based on the total dry powder volume.

5. A process according to claim 1 wherein the grinding chamber is provided with separation means at an outlet placed at the essentially horizontal axis in the center of the grinding chamber in one end of the grinding chamber.

6. A process according to claim 5 wherein the separation means is an sieve that is protruding into the hollow agitator.

7. A process according to claim 1 wherein the slurry is further circulated through a stirred tank before returning to the grinding chamber.

8. A process according to claim 2 wherein the powder(s) forming binder phase is one or more of Co, Ni or Fe in an amount of 2 to 30 wt % based on the total dry powder weight.

9. A process according to claim 2 wherein a pressing agent being polyethylene glycol or wax is added to the milling apparatus in an amount of between 15 and 25 vol % based on the total dry powder volume.
